(19) United States
(12) Patent Application Publication
(10) Pub. No.: US 2026/0255217 A1
(43) Pub. Date: Aug. 27, 2026

(54) CHANNEL SELECTION FOR NON-PRIMARY CHANNEL ACCESS

(71) Applicant: Nokia Technologies Oy, Espoo (FI)

(72) Inventors: Klaus Doppler, Albany, CA (US); Salvatore Talarico, Los Gatos, CA (US); Behnam Dezfouli, San Jose, CA (US); Kerstin Johnsson, Palo Alto, CA (US); Davis Robertson, New York, NY (US); Prabodh Varshney, Irving, TX (US); Mikhail Liubogoshchev, Munich (DE); Orhan Okan Mutgan, Munich (DE)

(21) Appl. No.: 19/061,765

(22) Filed: Feb. 24, 2025

(51) Int. Cl. H04W 28/082; H04L 1/00; H04L 5/00; H04W 28/08

(52) U.S. Cl. CPC H04W 28/082; H04L 1/0068; H04L 5/0092; H04W 28/0983

(57) ABSTRACT

An apparatus, method, and computer program product are provided for determining one or more wireless channels are used by at least one overlapping basic service set, OBSS; receiving channelization information associated with two or more wireless channels including a wireless channel selected for non-primary channel access, NPCA, based on the one or more wireless channels used by the at least one OBSS, wherein the two or more wireless channels are selected to maximize usable bandwidth or avoid wireless channels used by the at least one OBSS; and exchanging data via the two or more wireless channels including the wireless channel selected for NPCA.

### TECHNOLOGICAL FIELD

Various example embodiments relate generally to wireless communication networks such as Wi-Fi in which latency sensitive applications may be employed.

### BACKGROUND

Some applications of wireless technology rely on low-latency. For example, a communications system may rely on providing low latency for stations (STAs) running latency-sensitive applications, such as virtual reality, mixed reality, augmented reality, or the like.

### BRIEF SUMMARY

An apparatus, method and computer program product are provided for determining and receiving channelization information associated with Non-Primary Channel Access (NPCA).

According to an aspect of the present disclosure, there is provided an apparatus including at least one processor and at least one memory storing instructions that, when executed by the at least one processor, cause the apparatus to perform at least determining one or more wireless channels are used by at least one overlapping basic service set, OBSS. The apparatus is also caused to perform receiving channelization information associated with two or more wireless channels including a wireless channel selected for non-primary channel access, NPCA, based on the one or more wireless channels used by the at least one OBSS. The two or more wireless channels are selected to maximize usable bandwidth or avoid wireless channels used by the at least one OBSS. The apparatus is also caused to perform exchanging data via the two or more wireless channels including the wireless channel selected for NPCA.

The apparatus of some embodiments is also caused to perform transmitting an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels by the at least one OBSS, information about a received signal strength associated with one or more of the one or more wireless channels used by the at least one OBSS, or information about a preferred NPCA primary channel. The apparatus of some embodiments is also caused to perform receiving an activity report request that requests a report of OBSS activity and defines time information defining a duration to measure the OBSS activity. In this embodiment, the activity report is transmitted in response to the activity report request. In some embodiments, the activity report is transmitted based on a predetermined time interval. In some embodiments, determining the one or more wireless channels are used by the at least one OBSS includes receiving signaling indicative of the one or more wireless channels being used by the at least one OBSS.

According to another aspect of the present disclosure, there is provided a method including determining one or more wireless channels are used by at least one overlapping basic service set, OBSS. The method further includes receiving channelization information associated with two or more wireless channels including a wireless channel selected for non-primary channel access, NPCA, based on the one or more wireless channels used by the at least one OBSS. The two or more wireless channels are selected to maximize usable bandwidth or avoid wireless channels used by the at least one OBSS. The method further includes exchanging data via the two or more wireless channels including the wireless channel selected for NPCA.

The method of some embodiments further includes transmitting an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels by the at least one OBSS, information about a received signal strength associated with one or more of the one or more wireless channels used by the at least one OBSS, or information about a preferred NPCA primary channel. The method of some embodiments further includes receiving an activity report request that requests a report of OBSS activity and defines time information defining a duration to measure the OBSS activity. In this embodiment, the activity report is transmitted in response to the activity report request. In some embodiments, the activity report is transmitted based on a predetermined time interval. In some embodiments, determining the one or more wireless channels are used by the at least one OBSS includes receiving signaling indicative of the one or more wireless channels being used by the at least one OBSS.

According to another aspect of the present disclosure, there is provided a computer program product, including at least one non-transitory computer-readable storage medium having computer-executable program code portions stored therein with the computer-executable program code portions comprising program code instructions configured to determine one or more wireless channels are used by at least one overlapping basic service set, OBSS. The computer-executable program code portions include program code instructions configured to receive channelization information associated with two or more wireless channels including a wireless channel selected for non-primary channel access, NPCA, based on the one or more wireless channels used by the at least one OBSS. The two or more wireless channels are selected to maximize usable bandwidth or avoid wireless channels used by the at least one OBSS. The computer-executable program code portions include program code instructions configured to exchange data via the two or more wireless channels including the wireless channel selected for NPCA.

According to some embodiments, the computer-executable program code portions include program code instructions configured to transmit an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels by the at least one OBSS, information about a received signal strength associated with one or more of the one or more wireless channels used by the at least one OBSS, or information about a preferred NPCA primary channel. According to some embodiments, the computer-executable program code portions include program code instructions configured to receive an activity report request that requests a report of OBSS activity and defines time information defining a duration to measure the OBSS activity. In this embodiment, the activity report is transmitted in response to the activity report request. In some embodiments, the activity report is transmitted based on a predetermined time interval. In some embodiments, determining the one or more wireless channels are used by the at least one OBSS includes receiving signaling indicative of the one or more wireless channels being used by the at least one OBSS.

According to another aspect of the present disclosure, there is provided an apparatus including means for determining one or more wireless channels are used by at least one overlapping basic service set, OBSS. The apparatus also includes means for receiving channelization information associated with two or more wireless channels including a wireless channel selected for non-primary channel access, NPCA, based on the one or more wireless channels used by the at least one OBSS. The two or more wireless channels are selected to maximize usable bandwidth or avoid wireless channels used by the at least one OBSS. The apparatus also includes means for exchanging data via the two or more wireless channels including the wireless channel selected for NPCA.

The apparatus of some embodiments also includes means for transmitting an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels by the at least one OBSS, information about a received signal strength associated with one or more of the one or more wireless channels used by the at least one OBSS, or information about a preferred NPCA primary channel. The apparatus of some embodiments also includes means for receiving an activity report request that requests a report of OBSS activity and defines time information defining a duration to measure the OBSS activity. In this embodiment, the activity report is transmitted in response to the activity report request. In some embodiments, the activity report is transmitted based on a predetermined time interval. In some embodiments, determining the one or more wireless channels are used by the at least one OBSS includes receiving signaling indicative of the one or more wireless channels being used by the at least one OBSS.

According to another aspect of the present disclosure, there is provided an apparatus including at least one processor and at least one memory storing instructions that, when executed by the at least one processor, cause the apparatus to perform at least determining one or more wireless channels are used by at least one overlapping basic service set, OBSS; selecting, based at least in part on the one or more wireless channels used by the at least one OBSS, two or more wireless channels based on and including a wireless channel selected for non-primary channel access, NPCA, by: selecting an NPCA primary channel; and selecting one or more additional wireless channels that are based on the NPCA primary channel. The NPCA primary channel and the one or more additional wireless channels are selected to maximize usable bandwidth or avoid wireless channels used by the at least one OBSS. The apparatus is also caused to perform at least determining channelization information associated with the two or more wireless channels; and signaling the channelization information to one or more stations, STAs.

The apparatus of some embodiments is also caused to perform transmitting an activity report request to at least one of one or more non-access point, non-AP, stations, STAs, or one or more Aps. In this embodiment, the activity report request requests a report of OBSS activity and defines time information defining a duration to measure the OBSS activity. The apparatus of some embodiments is also caused to perform receiving an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels used by the at least one OBSS, information about a received signal strength associated with one or more of the one or more wireless channels used by the at least one OBSS, or information about a preferred NPCA primary channel, and wherein selecting the NPCA primary channel and the one or more additional wireless channels to maximize usable bandwidth or avoid wireless channels used by the at least one OBSS comprises selecting the NPCA primary channel and the one or more additional wireless channels based on the activity report.

The apparatus of some embodiments is also caused to perform measuring at least one parameter associated with the one or more wireless channels used by the at least one OBSS. In this embodiment, selecting the NPCA primary channel and the one or more additional wireless channels to maximize usable bandwidth or avoid wireless channels used by the at least one OBSS includes selecting the NPCA primary channel and the one or more additional wireless channels based on the measuring of the at least one parameter.

According to some embodiments, selecting the NPCA primary channel and the one or more additional wireless channels to maximize usable bandwidth or avoid wireless channels used by the at least one OBSS includes at least one of: selecting wireless channels determined to have no OBSS activity; selecting wireless channels determined to have an amount of OBSS activity that satisfies an activity threshold; or selecting wireless channels determined to have a received signal strength associated with OBSS activity that satisfies a received signal strength threshold.

According to some embodiments, a basic service set, BSS, includes the one or more wireless channels used by the OBSS and the two or more wireless channels based on and including the wireless channel selected for NPCA; the BSS is associated with a first channelization configuration; and the channelization information is associated with a second channelization configuration different from the first channelization configuration.

According to another aspect of the present disclosure, there is provided a method including determining one or more wireless channels are used by at least one overlapping basic service set, OBSS; selecting, based at least in part on the one or more wireless channels used by the at least one OBSS, two or more wireless channels based on and including a wireless channel selected for non-primary channel access, NPCA, by: selecting an NPCA primary channel; and selecting one or more additional wireless channels that are based on the NPCA primary channel. The NPCA primary channel and the one or more additional wireless channels are selected to maximize usable bandwidth or avoid wireless channels used by the at least one OBSS. The method further includes determining channelization information associated with the two or more wireless channels; and signaling the channelization information to one or more stations, STAs.

The method of some embodiments further includes transmitting an activity report request to at least one of one or more non-access point, non-AP, stations, STAs, or one or more Aps. In this embodiment, the activity report request requests a report of OBSS activity and defines time information defining a duration to measure the OBSS activity. The method of some embodiments further includes receiving an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels used by the at least one OBSS, information about a received signal strength associated with one or more of the one or more wireless channels used by the at least one OBSS, or information about a preferred NPCA primary channel, and wherein selecting the NPCA primary channel and the one or more additional wireless channels to maximize usable bandwidth or avoid wireless channels used by the at least one OBSS comprises selecting the NPCA primary channel and the one or more additional wireless channels based on the activity report.

The method of some embodiments further includes measuring at least one parameter associated with the one or more wireless channels used by the at least one OBSS. In this embodiment, selecting the NPCA primary channel and the one or more additional wireless channels to maximize usable bandwidth or avoid wireless channels used by the at least one OBSS includes selecting the NPCA primary channel and the one or more additional wireless channels based on the measuring of the at least one parameter.

According to some embodiments, selecting the NPCA primary channel and the one or more additional wireless channels to maximize usable bandwidth or avoid wireless channels used by the at least one OBSS includes at least one of: selecting wireless channels determined to have no OBSS activity; selecting wireless channels determined to have an amount of OBSS activity that satisfies an activity threshold; or selecting wireless channels determined to have a received signal strength associated with OBSS activity that satisfies a received signal strength threshold.

According to some embodiments, a basic service set, BSS, includes the one or more wireless channels used by the OBSS and the two or more wireless channels based on and including the wireless channel selected for NPCA; the BSS is associated with a first channelization configuration; and the channelization information is associated with a second channelization configuration different from the first channelization configuration.

According to another aspect of the present disclosure, there is provided a computer program product, including at least one non-transitory computer-readable storage medium having computer-executable program code portions stored therein with the computer-executable program code portions comprising program code instructions configured to determine one or more wireless channels are used by at least one overlapping basic service set, OBSS; select, based at least in part on the one or more wireless channels used by the at least one OBSS, two or more wireless channels based on and including a wireless channel selected for non-primary channel access, NPCA, by: selecting an NPCA primary channel; and selecting one or more additional wireless channels that are based on the NPCA primary channel. The NPCA primary channel and the one or more additional wireless channels are selected to maximize usable bandwidth or avoid wireless channels used by the at least one OBSS. The computer-executable program code portions include program code instructions configured to determine channelization information associated with the two or more wireless channels; and signal the channelization information to one or more stations, STAs.

According to some embodiments, the computer-executable program code portions include program code instructions configured to transmit an activity report request to at least one of one or more non-access point, non-AP, stations, STAs, or one or more Aps. In this embodiment, the activity report request requests a report of OBSS activity and defines time information defining a duration to measure the OBSS activity. According to some embodiments, the computer-executable program code portions include program code instructions configured to receive an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels used by the at least one OBSS, information about a received signal strength associated with one or more of the one or more wireless channels used by the at least one OBSS, or information about a preferred NPCA primary channel, and wherein selecting the NPCA primary channel and the one or more additional wireless channels to maximize usable bandwidth or avoid wireless channels used by the at least one OBSS comprises selecting the NPCA primary channel and the one or more additional wireless channels based on the activity report.

According to some embodiments, the computer-executable program code portions include program code instructions configured to measure at least one parameter associated with the one or more wireless channels used by the at least one OBSS. In this embodiment, selecting the NPCA primary channel and the one or more additional wireless channels to maximize usable bandwidth or avoid wireless channels used by the at least one OBSS includes selecting the NPCA primary channel and the one or more additional wireless channels based on the measuring of the at least one parameter.

According to some embodiments, selecting the NPCA primary channel and the one or more additional wireless channels to maximize usable bandwidth or avoid wireless channels used by the at least one OBSS includes at least one of: selecting wireless channels determined to have no OBSS activity; selecting wireless channels determined to have an amount of OBSS activity that satisfies an activity threshold; or selecting wireless channels determined to have a received signal strength associated with OBSS activity that satisfies a received signal strength threshold.

According to some embodiments, a basic service set, BSS, includes the one or more wireless channels used by the OBSS and the two or more wireless channels based on and including the wireless channel selected for NPCA; the BSS is associated with a first channelization configuration; and the channelization information is associated with a second channelization configuration different from the first channelization configuration.

According to another aspect of the present disclosure, there is provided an apparatus including means for determining one or more wireless channels are used by at least one overlapping basic service set, OBSS; selecting, based at least in part on the one or more wireless channels used by the at least one OBSS, two or more wireless channels based on and including a wireless channel selected for non-primary channel access, NPCA, by: selecting an NPCA primary channel; and selecting one or more additional wireless channels that are based on the NPCA primary channel. The NPCA primary channel and the one or more additional wireless channels are selected to maximize usable bandwidth or avoid wireless channels used by the at least one OBSS. The method further includes determining channelization information associated with the two or more wireless channels; and signaling the channelization information to one or more stations, STAs.

The apparatus of some embodiments also includes means for transmitting an activity report request to at least one of one or more non-access point, non-AP, stations, STAs, or one or more Aps. In this embodiment, the activity report request requests a report of OBSS activity and defines time information defining a duration to measure the OBSS activity. The apparatus of some embodiments also includes means for receiving an activity report associated with the one or more wireless channels used by the at least one OBSS. In this embodiment, the activity report includes at least one of the following: information identifying the at least one OBSS, information identifying the one or more wireless channels used by the at least one OBSS, information about usage of the one or more wireless channels used by the at least one OBSS, information about a received signal strength associated with one or more of the one or more wireless channels used by the at least one OBSS, or information about a preferred NPCA primary channel, and wherein selecting the NPCA primary channel and the one or more additional wireless channels to maximize usable bandwidth or avoid wireless channels used by the at least one OBSS comprises selecting the NPCA primary channel and the one or more additional wireless channels based on the activity report.

The apparatus of some embodiments also includes means for measuring at least one parameter associated with the one or more wireless channels used by the at least one OBSS. In this embodiment, selecting the NPCA primary channel and the one or more additional wireless channels to maximize usable bandwidth or avoid wireless channels used by the at least one OBSS includes selecting the NPCA primary channel and the one or more additional wireless channels based on the measuring of the at least one parameter.

According to some embodiments, selecting the NPCA primary channel and the one or more additional wireless channels to maximize usable bandwidth or avoid wireless channels used by the at least one OBSS includes at least one of: selecting wireless channels determined to have no OBSS activity; selecting wireless channels determined to have an amount of OBSS activity that satisfies an activity threshold; or selecting wireless channels determined to have a received signal strength associated with OBSS activity that satisfies a received signal strength threshold.

According to some embodiments, a basic service set, BSS, includes the one or more wireless channels used by the OBSS and the two or more wireless channels based on and including the wireless channel selected for NPCA; the BSS is associated with a first channelization configuration; and the channelization information is associated with a second channelization configuration different from the first channelization configuration.

According to another aspect of the present disclosure, there is provided an apparatus including at least one processor and at least one memory storing instructions that, when executed by the at least one processor, cause the apparatus to perform at least receiving channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The apparatus is also caused to perform exchanging data via the two or more wireless channels including the wireless channel selected for NPCA.

According to another aspect of the present disclosure, there is provided a method including receiving channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The method further includes exchanging data via the two or more wireless channels including the wireless channel selected for NPCA.

According to another aspect of the present disclosure, there is provided a computer program product, including at least one non-transitory computer-readable storage medium having computer-executable program code portions stored therein with the computer-executable program code portions comprising program code instructions configured to receive channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The computer-executable program code portions include program code instructions configured to exchange data via the two or more wireless channels including the wireless channel selected for NPCA.

According to another aspect of the present disclosure, there is provided an apparatus including means for receiving channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The apparatus also includes means for exchanging data via the two or more wireless channels including the wireless channel selected for NPCA.

According to another aspect of the present disclosure, there is provided an apparatus including at least one processor and at least one memory storing instructions that, when executed by the at least one processor, cause the apparatus to perform at least determining channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The apparatus is also caused to perform signaling the channelization information to one or more stations, STAs.

According to some embodiments, signaling the channelization information includes indicating the NPCA primary channel. Signaling the channelization information in some embodiments includes indicating the NPCA primary channel in at least one of a beacon frame, management frame, probe frame, or (re-)association frame. Signaling the channelization information in some embodiments includes indicating the NPCA primary channel as part of an NPCA operation information field. Signaling the channelization information in some embodiments includes indicating, via a bitmap in a subfield of an NPCA operation information field, the two or more wireless channels. Signaling the channelization information in some embodiments includes indicating, via an NPCA channelization offset subfield of an NPCA operation information field, a first wireless channel or a last wireless channel of the two or more wireless channels relative to the NPCA primary channel. Signaling the channelization information in some embodiments includes indicating, via a disabled subchannel bitmap subfield, one or more wireless channels that are punctured in association with the two or more wireless channels. Signaling the channelization information of some embodiments includes indicating, via a bitmap within an NPCA operation information field, one or more wireless channels that are punctured in association with the two or more wireless channels. Signaling the channelization information in some embodiments includes indicating the NPCA primary channel as a first wireless channel or a last wireless channel of the two or more wireless channels. In some embodiments, signaling the channelization information is based on a carrier frequency associated with the one or more STAs. In some embodiments, a basic service set, BSS, includes the two or more wireless channels; the BSS is associated with a first channelization configuration; and the channelization information is associated with a second channelization configuration different from the first channelization configuration.

According to another aspect of the present disclosure, there is provided a method including determining channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The method further includes signaling the channelization information to one or more stations, STAs.

According to some embodiments, signaling the channelization information includes indicating the NPCA primary channel. Signaling the channelization information in some embodiments includes indicating the NPCA primary channel in at least one of a beacon frame, management frame, probe frame, or (re-)association frame. Signaling the channelization information in some embodiments includes indicating the NPCA primary channel as part of an NPCA operation information field. Signaling the channelization information in some embodiments includes indicating, via a bitmap in a subfield of an NPCA operation information field, the two or more wireless channels. Signaling the channelization information in some embodiments includes indicating, via an NPCA channelization offset subfield of an NPCA operation information field, a first wireless channel or a last wireless channel of the two or more wireless channels relative to the NPCA primary channel. Signaling the channelization information in some embodiments includes indicating, via a disabled subchannel bitmap subfield, one or more wireless channels that are punctured in association with the two or more wireless channels. Signaling the channelization information of some embodiments includes indicating, via a bitmap within an NPCA operation information field, one or more wireless channels that are punctured in association with the two or more wireless channels. Signaling the channelization information in some embodiments includes indicating the NPCA primary channel as a first wireless channel or a last wireless channel of the two or more wireless channels. In some embodiments, signaling the channelization information is based on a carrier frequency associated with the one or more STAs. In some embodiments, a basic service set, BSS, includes the two or more wireless channels; the BSS is associated with a first channelization configuration; and the channelization information is associated with a second channelization configuration different from the first channelization configuration.

According to another aspect of the present disclosure, there is provided a computer program product, including at least one non-transitory computer-readable storage medium having computer-executable program code portions stored therein with the computer-executable program code portions comprising program code instructions configured to determine channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The computer-executable program code portions include program code instructions configured to signal the channelization information to one or more stations, STAs.

According to some embodiments, signaling the channelization information includes indicating the NPCA primary channel. Signaling the channelization information in some embodiments includes indicating the NPCA primary channel in at least one of a beacon frame, management frame, probe frame, or (re-)association frame. Signaling the channelization information in some embodiments includes indicating the NPCA primary channel as part of an NPCA operation information field. Signaling the channelization information in some embodiments includes indicating, via a bitmap in a subfield of an NPCA operation information field, the two or more wireless channels. Signaling the channelization information in some embodiments includes indicating, via an NPCA channelization offset subfield of an NPCA operation information field, a first wireless channel or a last wireless channel of the two or more wireless channels relative to the NPCA primary channel. Signaling the channelization information in some embodiments includes indicating, via a disabled subchannel bitmap subfield, one or more wireless channels that are punctured in association with the two or more wireless channels. Signaling the channelization information of some embodiments includes indicating, via a bitmap within an NPCA operation information field, one or more wireless channels that are punctured in association with the two or more wireless channels. Signaling the channelization information in some embodiments includes indicating the NPCA primary channel as a first wireless channel or a last wireless channel of the two or more wireless channels. In some embodiments, signaling the channelization information is based on a carrier frequency associated with the one or more STAs. In some embodiments, a basic service set, BSS, includes the two or more wireless channels; the BSS is associated with a first channelization configuration; and the channelization information is associated with a second channelization configuration different from the first channelization configuration.

According to another aspect of the present disclosure, there is provided an apparatus including means for determining channelization information associated with two or more wireless channels based on and including a wireless channel selected for non-primary channel access, NPCA. The two or more wireless channels include an NPCA primary channel and one or more additional wireless channels selected based on the NPCA primary channel, and the two or more wireless channels are selected to maximize usable bandwidth or avoid wireless channels used by at least one overlapping basic service set, OBSS. The apparatus also includes means for signaling the channelization information to one or more stations, STAs.

According to some embodiments, signaling the channelization information includes indicating the NPCA primary channel. Signaling the channelization information in some embodiments includes indicating the NPCA primary channel in at least one of a beacon frame, management frame, probe frame, or (re-)association frame. Signaling the channelization information in some embodiments includes indicating the NPCA primary channel as part of an NPCA operation information field. Signaling the channelization information in some embodiments includes indicating, via a bitmap in a subfield of an NPCA operation information field, the two or more wireless channels. Signaling the channelization information in some embodiments includes indicating, via an NPCA channelization offset subfield of an NPCA operation information field, a first wireless channel or a last wireless channel of the two or more wireless channels relative to the NPCA primary channel. Signaling the channelization information in some embodiments includes indicating, via a disabled subchannel bitmap subfield, one or more wireless channels that are punctured in association with the two or more wireless channels. Signaling the channelization information of some embodiments includes indicating, via a bitmap within an NPCA operation information field, one or more wireless channels that are punctured in association with the two or more wireless channels. Signaling the channelization information in some embodiments includes indicating the NPCA primary channel as a first wireless channel or a last wireless channel of the two or more wireless channels. In some embodiments, signaling the channelization information is based on a carrier frequency associated with the one or more STAs. In some embodiments, a basic service set, BSS, includes the two or more wireless channels; the BSS is associated with a first channelization configuration; and the channelization information is associated with a second channelization configuration different from the first channelization configuration.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a diagram of an example communication system in accordance with at least an example embodiment;

FIG. 2 an example of a typical selection of the NPCA primary channel in the unlicensed 5 GHz band;

FIG. 3 illustrates an example diagram for how channel selection may occur;

FIG. 4 illustrates an example diagram for how channel selection may occur in accordance with at least an example embodiment;

FIG. 5 illustrates an example of channelization in accordance with at least an example embodiment;

FIG. 6 illustrates an example of NPCA channelization signaling in accordance with at least an example embodiment;

FIG. 7 illustrates an example of NPCA channelization signaling in accordance with at least an example embodiment;

FIG. 8 illustrates an example of NPCA channelization signaling in accordance with some embodiments described herein;

FIG. 9 illustrates the operations performed, such as by the apparatus of FIG. 13, in accordance with at least an example embodiment;

FIG. 10 illustrates the operations performed, such as by the apparatus of FIG. 13, in accordance with at least an example embodiment;

FIG. 11 illustrates the operations performed, such as by the apparatus of FIG. 13, in accordance with at least an example embodiment;

FIG. 12 illustrates the operations performed, such as by the apparatus of FIG. 13, in accordance with at least an example embodiment; and

FIG. 13 is a block diagram of an apparatus that may be specifically configured in accordance with an example embodiment of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Certain embodiments described may be implemented in a communications system (e.g., a communication network), such as any of the following radio access technologies (RATs): wireless fidelity (Wi-Fi), BLUETOOTH, Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunications system (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future radio access technology (RAT) such as 6G. Moreover, communication within the communication network may utilize any suitable wireless communication technology, comprising but not limited to:

Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiplexing (OFDM), and/or Discrete Fourier Transform spread OFDM (DFT-s-OFDM).

The term “terminal device” refers to any end device that may be capable of wireless communication. By way of example, a terminal device may be referred to as a communication device, user equipment (UE), a Subscriber Station (SS), a Mobile Station (MS). The terminal device may include a mobile phone, a cellular phone, a smart phone, voice over IP (VoIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, universal serial bus (USB) USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

The term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving respectively via a wireless propagation channel on radio resources.

In some examples, a communications system may be deployed in a wireless local area network (WLAN), such as a Wi-Fi network. That is, in some examples, a communications system may be an example of a WLAN system. The WLAN system may support wireless communications between one or more communications devices in accordance with one or more Wi-Fi protocols, such as protocols based on institute of electrical and electronics engineers (IEEE) 802.11 standards and/or related drafts, such as 802.11-2020, 802.11ac, 802.11ax, 802.11be, 802.11bn, and/or others.

In some examples, Wi-Fi communications may occur via one or more radio frequency bands, such as 2.4 gigahertz (GHz), 3.6 GHz, 5 GHz, 6 GHz, 60 GHz, and/or the like. In some such examples, each radio frequency band may support one or more channels (e.g., 20 megahertz (MHz) channels) over which data may be communicated. In some examples, multiple devices may use multiple channels to communicate over the WLAN simultaneously.

A WLAN system may include one or more communications devices, such as an access point (AP) and/or a station (STA), which is also referred to herein as a non-AP STA. For example, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID) or a basic service set identifier (BSSID).

In some examples, an AP of a WLAN system includes at least one distribution system access function configured to facilitate data communication beyond the AP. Additionally, or alternatively, STAs may be configured to be end devices, which rely on association with an AP to communicate with devices other than the AP. An AP may be configured to connect to a wired local area network (LAN) (e.g., via Ethernet). The AP may allow one or more client devices (e.g., STAs) to access wireless connections via WLAN. The client devices may also be referred to as “WLAN clients”. WLAN clients may comprise various devices and/or types of devices, including laptops, tablets, cell phones, and/or other devices.

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity, which may be configured to act as a network manager. In some examples, the network manager is a cloud-based entity, which may reside either in a private cloud or in a public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more STAs (also referred to as clients or client devices) may wirelessly connect to other devices in a peer-to-peer network.

Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDU, wherein a payload of a PDU may comprise user data, control data, management data, and/or other data. In some examples, a WLAN system may implement one or more security protocols to protect the confidentiality, integrity, and availability of Wi-Fi communications.

In some examples, a WLAN system may support transmission opportunities (TXOPs) to increase throughput, such as for high priority data, by providing contention-free channel access for a period of time. A TXOP may be available in a quality of service (QOS) mode as part of Enhanced Distributed Channel Access (EDCA), and/or may be a limited time period of contention-free channel access available to the channel-owning station (e.g., the TXOP holder). During such a period a TXOP holder, which may be a STA or an AP, may send multiple frames that satisfy criteria, which may have been determined for the use of TXOP. In some examples, the criteria may allow transmission of frames belonging to an access category (AC) other than the AC for which the TXOP has been obtained. In some examples, a TXOP may increase throughput and/or reduce delay of QoS data frames by eliminating contention periods between transmissions. In some examples, a TXOP may be used in combination with frame aggregation and block acknowledgement to further increase throughput.

In some examples, access categories have different channel access parameters, such as Arbitration Interframe Spacing (AIFS), duration, contention window size, and TXOP limit. In some examples, values of these parameters may be set in a manner that increases a likelihood of higher priority packets being prioritized over lower priority packets. For example, the values of the parameters may be set that a STA (typically) waits for a shorter duration before sending the higher priority packets compared to a duration that the STA may wait before sending the lower priority packets. Additionally, or alternatively, the values of the parameters may be set so that the contention window for higher priority packets is smaller than that of lower priority packets and/or so that multiple packets may be sent in a TXOP. In some examples, a TXOP holder, which may be either a STA or an AP, may send frames to multiple recipients during a TXOP. In addition to QoS data frames, other frames may be exchanged during the TXOP, such as an acknowledgement (ACK), BlockAckReq/BlockAck frames, and/or other control and management frames.

In some examples, a WLAN system uses multi-link operation (MLO) to improve data transmission (e.g., via using multiple frequency bands for transmissions). In some examples, MLO further comprises various features, including simultaneous transmit and receive (STR), multi-channel multi-radio (MCMR), enhanced multi-AP roaming (E-MAR), non-simultaneous transmit and receive (NSTR), multi-link multi-radio (MLMR), and/or other features.

An AP that supports MLO may be referred to as an AP multi-link device (MLD). An MLO-capable client, for example, such as a STA, may be referred to as a non-AP MLD. Such a client device may have two or more STAs with which it may establish links to an AP MLD. A connection between a STA and AP may represent a link between an AP MLD and a non-AP MLD. In some examples, APs which do not support MLO may be multi-band APs which have two or more APs operating in different bands and/or channels. An AP may operate in one or more bands and/or channels and a client device may connect to the AP via one or more of the bands and/or channels. For example, a client device may associate with the AP in one of the channels. An AP MLD may operate as a multi-band AP, while providing means for a multi-link (ML) capable client (non-AP MLD) to simultaneously use two or more of its radios and/or APs for communication with a single association. An AP MLD may be an MLMR, which is configured to communicate simultaneously with its APs with associated non-AP MLDs. Non-AP MLDs may have constraints (e.g., NSTR), which may indicate that simultaneous communication over established links is not possible. Therefore, in some such instances, a non-AP MLD may associate to an AP MLD. Accordingly, the non-AP MLD may be associated over two or more bands and/or channels and may communicate with the APs affiliated to the AP MLD over the established links.

WLAN devices configured with STR may be configured to allow simultaneous transmission and/or reception via different respective frequency bands, which may reduce latency. WLAN devices configured with MCMR may be configured to allow data transmission via two or more radios and/or channels, which may increase efficiency, reduce congestion, and/or increase network speeds. WLAN devices configured with enhanced multilink single-radio (EMLSR) may be configured to allow client devices to switch between multiple respective APs while maintaining their connections, which may allow more consistent connectivity. WLAN devices configured with NSTR may be configured to allow client devices to non-simultaneous transmission and/or reception via different respective frequency bands, which may reduce latency (particularly in comparison with single-link operation). WLAN devices configured with MLMR may be configured to allow different respective radios and/or channels to be used for managing respective links, which may reduce interference and/or improve network performance.

A WLAN system may be configured with various types of service sets, for example, such as basic service set (BSS) and/or an extended service set (ESS). A BSS may be comprised of an AP and one or more client devices (e.g., STAs) associated with the AP. The one or more client devices may have one or more common physical layer (PHY) medium access characteristics (e.g., radio frequency, modulation scheme, security settings, and/or the like). A BSSID may define the BSS such that the one or more client devices of the BSS share the same BSSID.

In some examples, two or more BSSs may have overlapping coverage areas, and they may operate with either partially or entirely same radio frequency channels. In such examples of overlapping BSSs (OBSSs), a client device may transmit frames from the area of overlap, and one or more other client devices may sense the transmission. Responsive to sensing the transmission, the one or more other client devices may cease their own transmissions. In some examples, if the other client devices do not sense the transmission, the other client devices may become hidden terminals with respect to the client device which is transmitting.

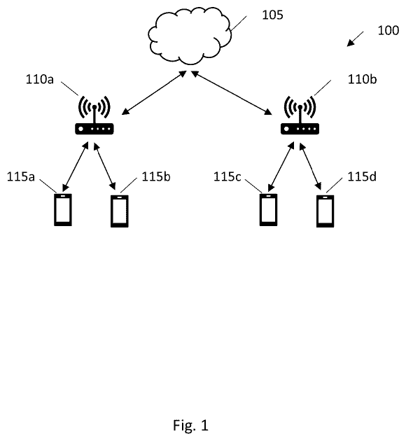

FIG. 1 illustrates an example communications system 100 to which one or more examples disclosed herein may be applied. The communications system 100 may include a cloud network 105, one or more APs (e.g., an AP 110-a, an AP 110-b), and one or more client devices, also referred to herein as STAs, connected to the one or more APs. For example, the communications system 100 may include a STA 115-a and a STA 115-b connected to the AP 110-a, as well as a STA 115-c and a STA 115-d connected to the AP 110-b. In some examples, the APs 110 may be mobile access points (mAPs) with constrained functionality. In some such examples, a configuration comprising an mAP and a STA may be implemented as part of a peer-to-peer connection, for example, as in Wi-Fi Direct or Wi-Fi Aware. In some examples, a device may simultaneously operate as a STA and as an AP. One such an example case is in a multi-AP or mesh network, which includes two or more devices that may act as APs and use Wi-Fi for the wireless backhaul connectivity based on a STA-AP connection model.

In some wireless communications systems, APs may provide wireless connectivity for one or more STAs according to the Wi-Fi standards, such as those that are a subset of the IEEE 802 family of standards. For example, the MAC and PHY specifications for Wi-Fi access points are defined by IEEE 802.11 for transmitting and receiving data in frequency bands such as 2.4 GHz, 3.6 GHz, 5 GHz, 6 GHz, 60 GHz, and/or the like. APs and STAs may communicate through the transmission of frames, including data frames, management frames, and/or control frames, which may be transmitted in unicast messages, broadcast messages, or multicast messages. The 802.11 standards define an inter-frame space (IFS) as the nominal time (in microseconds (us)) that the MAC and PHY use to receive the last symbol of a frame, process the frame, and respond with the first symbol of a response frame (e.g., the earliest possible response frame).

In the example of FIG. 1, the STAs 115 may be configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, STAs, UEs, and/or other entities suitable for such usage. For example, the communications system 100 may support radio frequency sensing during IFS.

The communications system 100 may support latency-sensitive applications at Wi-Fi devices (e.g., APs, STAs). Some such applications may include for example virtual reality (VR) applications, mixed reality applications, extended reality (XR) and augmented reality (AR) applications. In some cases, reliability and non-deterministic channel access, such as for wideband transmissions, may constrain a performance of latency-sensitive applications. For example, for a wideband transmission (or channel bonding), a device may use a primary 20 MHz channel to communicate control frames and management frames and may communicate data frames by bonding a BSS primary channel (also referred to herein as a reference primary channel or, more simply, a primary channel) with one or more other available 20 MHz channels, which are referred to as secondary channels. Channel bonding was introduced to provide for transmissions over multiple contiguous 20 MHz channels. In some instances, channel bonding may support transmissions over a total bandwidth of 40 MHz, 80 MHz, 160 MHz, or 320 MHz.

In some examples, if the device assesses the BSS primary channel to be idle, the device may perform a wideband transmission across a bandwidth including the BSS primary channel or the BSS primary channel and one or multiple contiguous secondary channels (e.g., totaling 40 MHz, 80 MHz, or 160 MHz or 320 MHz). In some instances, however, an overlapping basic service set (OBSS) transmission may overlap (partially or fully) with the BSS primary channel. In some such instances, the device may determine that the BSS primary channel is busy and, as such, may defer the wideband transmission. Consequently, the secondary channels may sit idle until the BSS primary channel is available, which may lead to reduced performance, for example, for latency-sensitive applications.

A procedure (e.g., a procedure defined in IEEE 802.11ac) may enable a device, such as a STA, to adjust a transmission bandwidth of the STA per TXOP to include 20 MHz, 40 MHz, 80 MHz, or 160 MHz based on channel availability. In some examples, however, the adjustment to the transmission bandwidth may be contingent upon the resulting bandwidth being contiguous, and the primary channel was assessed to be idle. For example, the STA may adjust the transmission bandwidth of the STA per TXOP to include 20 MHz, 40 MHz, 80 MHz, or 160 MHz based on channel availability so long as the resulting bandwidth is contiguous, and the primary channel was assessed to be idle. In some cases, however, such constraint may result in a substantial amount of unused spectrum, as some non-contiguous 20 MHz channels may be available, but sit idle due to the STA being constrained to using contiguous channels.

IEEE 802.11bn is the Task Group working on a specification that will be the basis of Wi-Fi 8. The main target of this Task Group is a marked reduction in latency for Wi-Fi Stations (STAs) running latency-sensitive applications such as VR, mixed reality, and AR.

One of the main limitations of IEEE 802.11's current design is its limited reliability and non-deterministic channel access, especially for wideband transmissions. When wideband transmission (or channel bonding) is used, the listen before talk (LBT) procedure is required on each of the 20 MHz channels comprising the overall bandwidth used in the transmission. When operating in this mode, one of those 20 MHz channels is selected as the primary channel. The primary channel is used as the reference channel to communicate critical control and management frames, as well as to support legacy STAs, while data frames are transmitted across the entire bandwidth (BW) by bonding the primary 20 MHz channel with all other available 20 MHz channels, which are called secondary channels. For an AP or non-AP STA to acquire a TXOP and perform a wideband transmission, it has to first “win” the primary channel via the Enhanced Distributed Channel Access (EDCA) procedure regardless of whether the secondary channels are idle or not for which the STA will perform a separate check via a point coordination function (PCF) interframe space (PIFS) Clear Channel Assessment (CCA).

To address the limitation associated with (primary) channel access mentioned above, the concept of Non-Primary Channel Access (NPCA) has been proposed in 802.11bn. The basic concept is to temporarily utilize an idle alternative channel as a primary channel, referred to herein as NPCA primary channel, when the BSS's primary channel is occupied by OBSS or other transmissions.

IEEE 802.11bn has agreed to define NPCA as a mode of operation that enables a STA to access a secondary channel when the primary channel is known to be busy due to OBSS traffic or other to-be-defined (TBD) conditions. See 24/171r26, “November-2024-working-group-motions.”

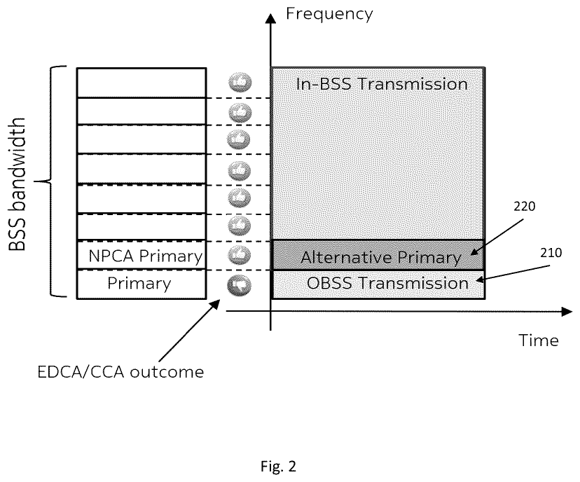

FIG. 2 illustrates an example of a typical selection of the NPCA primary channel in the unlicensed 5 GHz band. As shown, channel 210 is the primary channel of the BSS which then defines what 40, 80 and 160 MHz channel to use (which must also contain the primary channel 220). Typically, the NPCA primary channel will be selected to be far enough from the primary channel so that a different 40, 80 or 160 MHz can be taken into use. As shown, the NPCA primary channel 220 is selected as an alternative primary channel in response to the OBSS transmission occupying the primary channel 210. It can be observed from this example that the selection of the NPCA primary channel is limited.

Some example embodiments of the present disclosure provide technical improvements to these and other issues. For example, some embodiments described herein provide technical improvements for how to increase the flexibility of NPCA primary channel selection and/or to signal the choice of the NPCA primary channel together with the channelization.

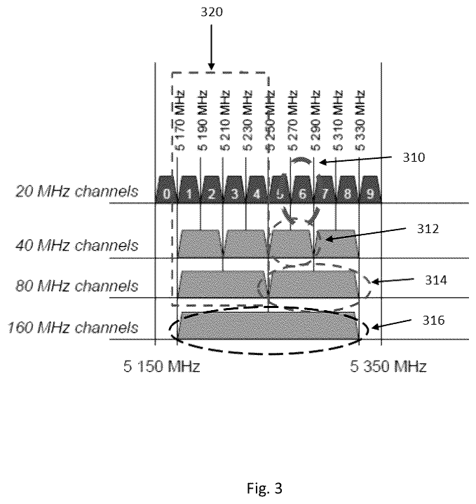

FIG. 3 illustrates an example diagram for how channel selection may occur. For example, a first BSS may use the 20 MHz channel 310 (the channel denoted as “6”) as its primary channel. When the first BSS makes a 40 MHz transmission, it may occupy the 40 MHz channel 312 (including channels denoted as “5” and “6”), when the first BSS makes an 80 MHz transmission, it may occupy the 80 MHz channel 314 (including channels denoted “5” through “8”), and when the first BSS makes a 160 MHz transmission, it may occupy the 160 MHz channel 316 (including channels denoted as “1” through “8”). In an example, a second OBSS may be operating on another 40 MHz channel (including channels denoted as “7” and “8”). If the second OBSS channels occupy the primary channel 310 of the first BSS, the first BSS will stop transmitting or select an NPCA primary channel. As mentioned above, in existing solutions, the first BSS may choose an NPCA primary channel to be far away, such as from the channels 320 (including channels denoted as “1” through “4”). As also described above, an issue arises for how to best select the NPCA primary channel to avoid channels occupied by any OBSSs (e.g., the second OBSS). This issue is worsened in cases with more dense deployments.

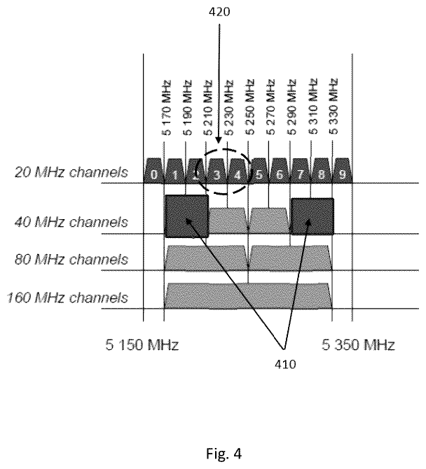

For example, FIG. 4 illustrates an example diagram for how channel selection may occur in accordance with some embodiments described herein. As shown, some channels are occupied by the OBSSs 410 (including channels denoted as “1,” “2,” “7,” and “8”). In existing solutions, if one of the OBSSs 410 occupy a primary channel of a BSS, the BSS may stop transmission even though additional channels (including channels denoted “3” through “6”) are unused by the OBSSs 410. However, using various techniques described herein, an example embodiment of the present disclosure may channelize two or more channel from the unused channels (including channels denoted as “3” through “6”) and select an NPCA primary channel therefrom, as shown at 420 and described in greater detail below.

Accordingly, various embodiments described herein provide technical improvements for AP and non-AP STAs to determine which channels are occupied by OBSSs. By determining which channels are occupied by OBSSs, an AP may select the NPCA primary channel in a manner that, for example, maximizes the available channels specific to a BSS's non-AP STAs' operating bandwidths and, for example, based on the channelization policies being used. Additionally, some example embodiments provide technical improvement by allowing for more flexibility in the channelization to, for example, maximize the usable channel bandwidth that is not occupied by OBSS transmissions. In some such embodiments, the channelization may not follow the current Wi-Fi channelization and may need to be signaled as NPCA parameters.

In some embodiments, maximizing usable channel bandwidth may include selecting channels that are unused by OBSSs or otherwise selecting channels to avoid channels that are used by OBSSs. Additionally or alternatively, in some embodiments, maximizing usable channel bandwidth may include using measurements associated with OBSS activity to make various determinations about OBSS activity associated with channels so that channels may be selected based thereon. For example, in some embodiments, maximizing usable channel bandwidth may include using on one or more measures associated with OBSS activity to select channels that are least used, relatively used less, used less than a predetermined amount, used less than a relative amount, and/or the like. For example, in some embodiments, such measures may include or otherwise be associated with static or dynamic threshold values, activity measures, received signal strength indicators, and/or the like.

In some embodiments, an AP may request non-AP STAs to provide activity reports. Such activity reports may include measurements based on OBSS activity within a non-AP STA's operating bandwidth. In some embodiments, a non-AP STA may take such measurements and/or transmit such activity reports upon request, periodically, or the like. In some embodiments, a default operation may be used (e.g., periodic measuring and/or reporting). In some embodiments, a non-AP STA may keep track of OBSS activity. Additionally or alternatively, in some embodiments, if an AP is involved in multi-AP coordination, the AP may request an activity report from one or more coordinating APs.

In various embodiments, activity reports may be transmitted as measurement request/response frames via management frames. In some embodiments, activity reports and/or requests may include, but are not limited to, the following information or fields: OBSS IDs; per OBSS ID: channels occupied (e.g., list of channels, bitmap, primary channel +operating bandwidth, etc.); per channel occupied by OBSS ID: activity measures (e.g., a percentage of channel usage) and/or measures of received signal strength (e.g., average received signal strength in dBm, RSSI value, etc.); a preferred NPCA channel; time information (e.g., a start time for measuring, an end time for measuring, a duration for measuring, etc.).

In some embodiments, an AP may use and/or combine information received (e.g., from activity reports) from its non-AP STAs to determine channels with least OBSS activity. Additionally or alternatively, in some embodiments, an AP may use and/or combine information from measurements taken by the AP to determine the channels with least OBSS activity. Additionally or alternatively, in some embodiments, an AP may use and/or combine information from its non-AP STAs and information from measurements taken by the AP to determine the channels with least OBSS activity. In any case, in some embodiments, an AP may then select an NPCA primary channel that maximizes the usable bandwidth. In some embodiments, selecting an NPCA primary channel that maximized the usable bandwidth may be based on the intersection of channels least used by OBSSs, the channelization policy in place, the operating bandwidths of the non-AP STAs, and/or the like. For example, referring to FIG. 4 above, an AP may select an NPCA channel from among the unused channels (including channels denoted as “3” through “6”), where no OBSS activity is present. In some embodiments, if all channels are in use by OBSSs, the AP may select the channels based on measurements associated with OBSS activity (e.g., channels with least OBSS activity).

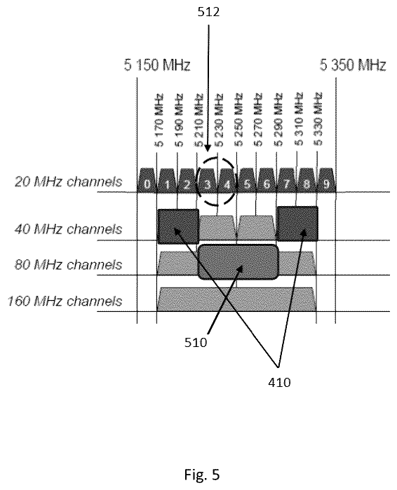

Certain example embodiments described herein may change the Wi-Fi channelization, for example, to allow an AP to select any (contiguous) channels for transmission. For example, FIG. 5 illustrates an example of channelization in accordance with some embodiments described herein. As discussed with reference to FIG. 4, the OBSSs 410 are occupying some of the channels (including channels denoted as “1,” “2,” “7,” and “8”). Instead of the BSS ceasing transmission, in accordance with the certain example embodiments described herein, the AP may create the new 80 MHz channel 510 (including channels denoted as “3” through “6”). The NPCA primary channel 512 may be selected (for example, from channels denoted as “3” or “4”). The channel 510 is selected to avoid the channels occupied by the activity of OBSSs 410 and maximizes usable bandwidth, for example, by making efficient use of the spectrum. Since NPCA is not supported by legacy STAs, this selection will not impact the operation of legacy STAs within the BSS. It is noted that if new channelization configurations are announced, they won't impact the complexity of blind detection at the receiver.

In an example, an AP may indicate its choice of NPCA primary channel (which may either be mandatory or optional) as part of the Ultra High Reliability (UHR) Operation element (e.g., in the dedicated field (B0-B7) of the NPCA Operation Information field), which may be, for example, contained in a beacon frame or any unicast or multicast management frame (e.g., probe frames, (re-)association frames, NPCA parameter update frames). In another example, the specific channelization (e.g., the group of (contiguous) channels that are bonded together to form a 40 MHz, 80 MHz, 160 MHz or 320 MHz band), sometimes referred to herein as the NPCA channelization, may be indicated, for example, in a new subfield within the NPCA Operation Information field. For example, such a field may be a bitmap or any other applicable manner of signaling the NPCA channelization.

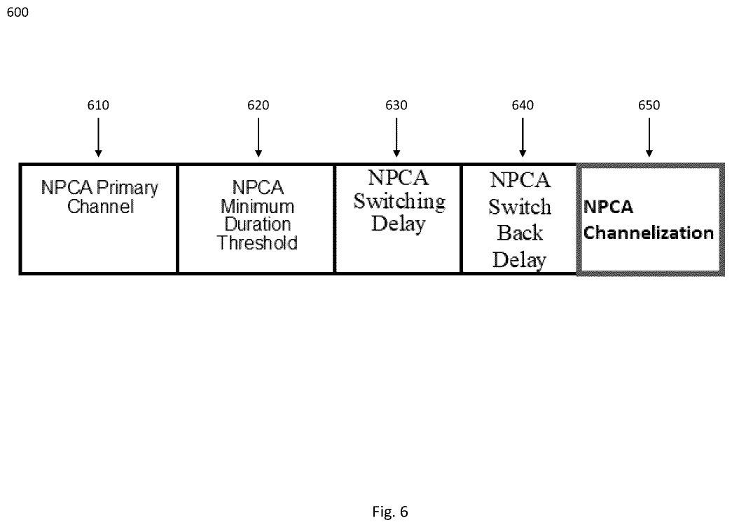

FIG. 6 illustrates an example of NPCA channelization signaling in accordance with some embodiments described herein. As shown, the example NPCA Operation Information field format 600 may include the NPCA primary channel 610 (e.g., at bits B0-B7), the NPCA minimum duration threshold 620, the NPCA switching delay 630, the NPCA switch back delay 640, and the NPCA channelization 650. In various embodiments, the interpretation of the bitmap may change based on the carrier frequency on which the device is operating (e.g., 2.4 GHz band, 5 GHz band or 6 GHz band).

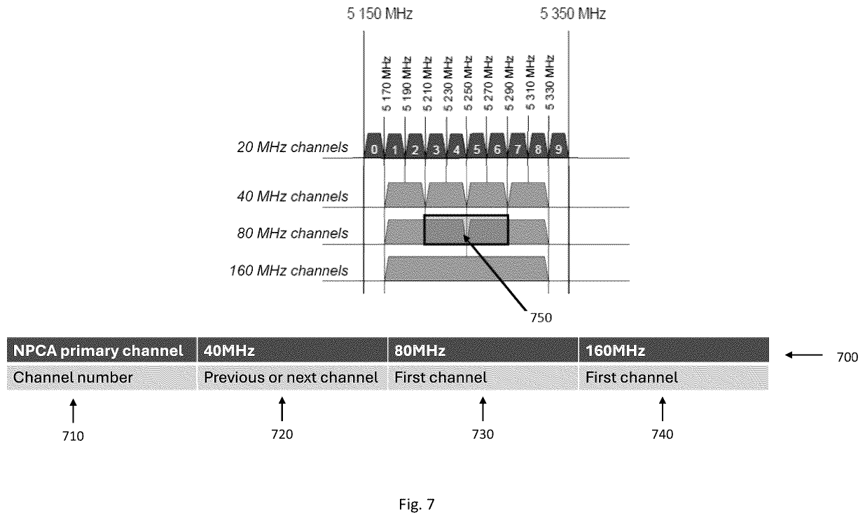

FIG. 7 illustrates an example of NPCA channelization signaling in accordance with some embodiments described herein. As shown, NPCA channelization signaling may occur for the channel 750 (including channels denoted as “3” through “6”). In some embodiments, the NPCA channelization for channel 750 may be indicated in an implicit manner. For example, the table 700 shows examples 710-740 which are various manners in which the NPCA channelization for channel 750 may be signaled. For example, as shown at 710, the channel number of the NPCA primary channel may be signaled. In another example, as shown at 720, for a 40 MHz BSS bandwidth, the NPCA primary channel may be the next or previous channel added to the NPCA primary channel to form a 40 MHz bandwidth. In another example, as shown at 730, for an 80 MHz BSS bandwidth, the NPCA primary channel may be the first (or last) of the 4 (contiguous) channels forming the 80 MHz bandwidth. In another example, as shown at 740, for a 160 MHz BSS bandwidth, the NPCA primary channel may be the first (or last) channel of the 8 (contiguous) channels forming the 160 MHz bandwidth. In yet another example, the signaling may be the first or last channel forming the contiguous 80 MHz bandwidth and the first or last channel forming the contiguous 160 MHz bandwidth.

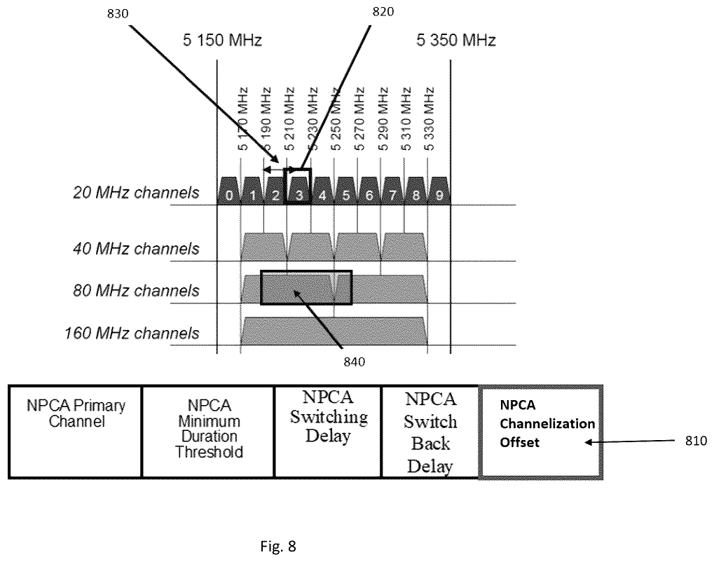

FIG. 8 illustrates an example of NPCA channelization signaling in accordance with some embodiments described herein. In various embodiments, the placement of the NPCA primary channel at the start or end of the NPCA bandwidth, as described with reference to FIG. 7, may be set by a specification or standard (e.g., implicit indication). Additionally or alternatively, in some embodiments, this may be set by the AP, for example, within the NPCA Operation Information field as part of a new field (e.g., explicit indication). In some embodiments, a new subfield, for example, the NPCA Channelization Offset 810, may be introduced into the NPCA Operation Information field, which may, for example, indicate the offset between the NPCA primary channel and the first (or last) channel of the NPCA channelization. For example, the NPCA primary channel 820 (including the channel denoted as “2”) of the channel 840 (including the channels denoted as “2” through “5”) is offset by one channel from the first channel 830 (including the channel denoted as “2”). Accordingly, the NPCA Channelization Offset 810 may indicate the offset of one channel between the first channel 830 (including the channel denoted as “2”) and the NPCA primary channel 820.

In some embodiments, the NPCA channelization may also include punctured 20 MHz channels as defined by 802.11ax and 802.11be. In some embodiments, if the NPCA channelization includes a punctured channel, the legacy bitmap (e.g., the Disabled Subchannel Bitmap subfield) may include the channels that are punctured. In some embodiments, if the NPCA channelization includes a punctured channel, a new bitmap may be included as a new subfield within the NPCA Operation Information field which may, for example, indicate the channels that are punctured.

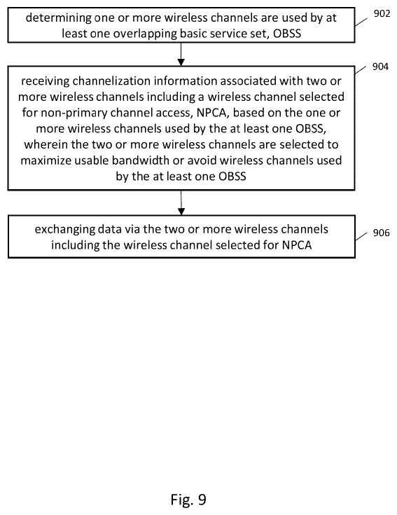

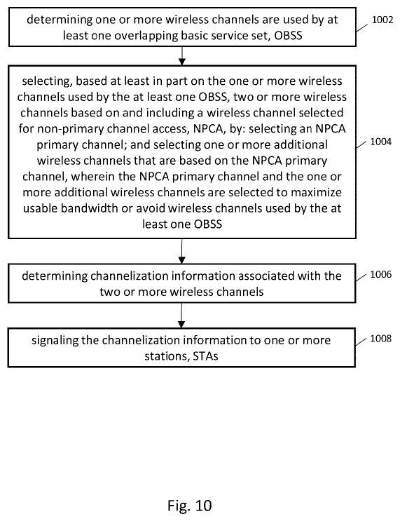

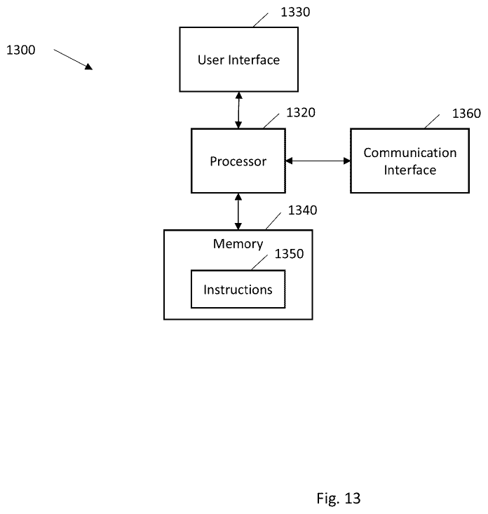

FIGS. 9 and 10 are flowcharts illustrating the operations performed for NPCA channelization in accordance with some of the embodiments disclosed herein. The flowchart of FIG. 9 illustrates the operations performed, such as by the apparatus 1300 of FIG. 13 as embodied by a STA, in order to support communications with an AP. The flowchart of FIG. 10 illustrates the operations performed, such as by the apparatus 1300 of FIG. 13 as embodied by the AP, in order to support communications with a STA.

In the example flowchart of FIG. 9, a STA (e.g., STAs 115) embodied, such as by apparatus 1300 of FIG. 13, includes means, such as the processor 1320, the communication interface 1360 or the like, for determining one or more wireless channels are used by at least one overlapping basic service set, OBSS, as shown in block 902. The determination may be performed by the apparatus 1300 based on operations of the processor 1320 and via communications interface 1360. The STA also includes means, such as the processor 1320, the communication interface 1360 or the like, for receiving channelization information associated with two or more wireless channels including a wireless channel selected for non-primary channel access, NPCA, based on the one or more wireless channels used by the at least one OBSS, wherein the two or more wireless channels are selected to maximize usable bandwidth or avoid wireless channels used by the at least one OBSS, as shown in block 904. The channelization information may be obtained by the processor 1320 via the communication interface 1360, for example, by receiving the channelization information directly or indirectly from the AP. The STA also includes means, such as the processor 1320, the communication interface 1360 or the like, for exchanging data via the two or more wireless channels including the wireless channel selected for NPCA, as shown in block 906.

In the example flowchart of FIG. 10, an AP (e.g., APs 110) which may be embodied by the apparatus 1300 of FIG. 13, includes means, such as the processor 1320, the communication interface 1360 or the like, for determining one or more wireless channels are used by at least one overlapping basic service set, OBSS, as shown in block 1002. The AP also includes means, such as the processor 1320, the communication interface 1360 or the like, for selecting, based at least in part on the one or more wireless channels used by the at least one OBSS, two or more wireless channels based on and including a wireless channel selected for non-primary channel access, NPCA, by: selecting an NPCA primary channel; and selecting one or more additional wireless channels that are based on the NPCA primary channel, wherein the NPCA primary channel and the one or more additional wireless channels are selected to maximize usable bandwidth or avoid wireless channels used by the at least one OBSS, as shown in block 1004. The AP also includes means, such as the processor 1320, the communication interface 1360 or the like, for determining channelization information associated with the two or more wireless channels, as shown in block 1006. The AP also includes means, such as the processor 1320, the communication interface 1360 or the like, for signaling the channelization information to one or more stations, STAs, as shown in block 1008.

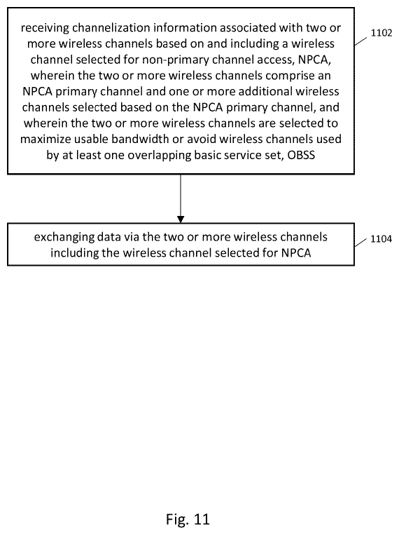

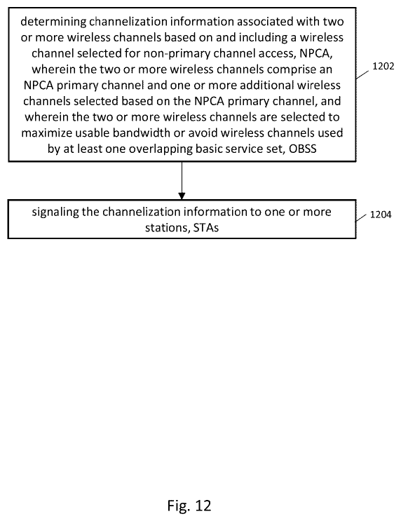

FIGS. 11 and 12 are flowcharts illustrating the operations performed in order to exchange data in association with NPCA in accordance with some of the embodiments disclosed herein. The flowchart of FIG. 11 illustrates the operations performed, such as by the apparatus 1300 of FIG. 13 as embodied by a STA, in order to support communications with an AP. The flowchart of FIG. 12 illustrates the operations performed, such as by the apparatus 1300 of FIG. 13 as embodied by the AP, in order to support communications with a STA.

In the example flowchart of FIG. 11, a STA (e.g., STAs 115) embodied, such as by apparatus 1300 of FIG. 13, includes means, such as the processor 1320, the communication interface 1360 or the like, for receiving channelization information associated with two or more wireless channels based on and including a wireless channel selected for non-primary channel access, NPCA, wherein the two or more wireless channels comprise an NPCA primary channel and one or more additional wireless channels selected based on the NPCA primary channel, and wherein the two or more wireless channels are selected to maximize usable bandwidth or avoid wireless channels used by at least one overlapping basic service set, OBSS, as shown in block 1102. The channelization information may be obtained by the processor 1320 via communications interface 1360, for example, by receiving the channelization information directly or indirectly from the AP. The STA also includes means, such as the processor 1320, the communication interface 1360 or the like, for exchanging data via the two or more wireless channels including the wireless channel selected for NPCA, as shown in block 1104. The data may be exchanged by the processor 1320 via the communication interface 1360, for example, by exchanging the data directly or indirectly with the AP or by Peer-to-Peer communication with another STA.

In the example flowchart of FIG. 12, an AP (e.g., APs 110) which may be embodied by the apparatus 1300 of FIG. 13, includes means, such as the processor 1320, the communication interface 1360 or the like, for determining channelization information associated with two or more wireless channels based on and including a wireless channel selected for non-primary channel access, NPCA, wherein the two or more wireless channels comprise an NPCA primary channel and one or more additional wireless channels selected based on the NPCA primary channel, and wherein the two or more wireless channels are selected to maximize usable bandwidth or avoid wireless channels used by at least one overlapping basic service set, OBSS, as shown in block 1202. The AP also includes means, such as the processor 1320, the communication interface 1360 or the like, for signaling the channelization information to one or more stations, STAs, as shown in block 1204. The channelization information may be signaled by the processor 1320 via the communication interface 1360, for example, by signaling the channelization information directly or indirectly to the STA(s).

FIGS. 9-12 are flowcharts illustrating methods according to certain example embodiments. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by instructions, such as for example computer program instructions. In this regard, the instructions which embody the procedures described above may be stored by the memory 1340 of an apparatus 1300 employing an example embodiment and executed by at least one processor 1320. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In FIG. 1, client devices 115 are configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, user equipment (UEs), and/or other entities suitable for such usage.

In some examples, the communications system 100 may support radiofrequency sensing during IFS. In some examples, the communications system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The network manager may include a processor and/or a memory (e.g., such as a processor 1320 and/or a memory 1340, further described with respect to FIG. 13). The processor 1320 may be used to execute the instructions 1350 stored in the memory 1340 and/or to store information in the memory 1340, for example, such as the results of the executed instructions.

The Wi-Fi APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver.

An apparatus 1300 may be implemented by a user device to which resources on the access interface are allocated and assigned, and thus any feature described herein with a user device may be implemented with a corresponding apparatus, such as the apparatus 1300. The Wi-Fi AP 110 may further include a processor (e.g., such as the processor 1320) and a memory (e.g., such as the memory 1340), such that the apparatus 1300 may also be embodied by an AP. The processor 1320 may be used to execute the instructions 1350 stored in the memory 1340 and/or to store information in the memory 1340, for example, such as the results of the executed instructions.

The apparatus 1300 may be configured to function as the cloud network 105, APs 110, client devices 115, and/or other entities. As shown in FIG. 13, the apparatus includes, is associated with, and/or is in communication with: a processor 1320, a memory 1340, and a communication interface 1360. The processor 1320 may be in communication with the memory device 1340 via a bus for passing information among components of the apparatus 1300. The memory device 1340 may be non-transitory and may include, for example, one or more volatile and/or non-volatile memories. In other words, for example, the memory device 1340 may be an electronic storage device (e.g., a computer readable storage medium) comprising gates configured to store data (e.g., bits) that may be retrievable by a machine (e.g., a computing device like the processor 1320). The memory device 1340 may be configured to store information, data, content, applications, instructions, or the like for enabling the apparatus to carry out various functions in accordance with an example embodiment of the present disclosure (e.g., the instructions 1350). For example, the memory device 1340 could be configured to buffer input data for processing by the processor 1320. Additionally or alternatively, the memory device 1340 may be configured to store the instructions 1350 for execution by the processor 1320.

The instructions 1350 may be comprised in a computer-readable medium or a non-transitory computer readable medium. A term “non-transitory”, as used herein, is a limitation of the medium itself (e.g., tangible, not a signal) as opposed to a limitation on data storage persistency (e.g., random access memory (RAM) vs. read only memory (ROM)).

FIG. 13 depicts an example of a simplified block diagram of an apparatus according to various embodiments of the present disclosure, whose implementation may differ from what is shown. The connections shown in FIG. 13 are logical connections; the actual physical connections may be different. It is apparent to a person skilled in the art that the system typically comprises also other functions and structures than those shown in FIG. 13.

The apparatus 1300 may, in some embodiments, be embodied in various computing or communication devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single system on a chip (SOC). As such, in some cases, a chip or chipset may constitute means for performing one or more operations for providing the functionalities described herein.

The processor 1320 may be embodied in a number of different ways. For example, the processor 1320 may be implemented by processing circuitry. For example, the processor 1320 may be embodied as one or more of various hardware processing means such as a coprocessor, a microprocessor, a controller, a digital signal processor (DSP), a processing element with or without an accompanying DSP, or various other circuitry including integrated circuits such as, for example, an application specific integrated circuit (ASIC), a field programmable gate array (FPGA), a microcontroller unit (MCU), a hardware accelerator, a special-purpose computer chip, and/or the like. As such, in some embodiments, the processor 1320 may include one or more processing cores configured to perform independently. A multi-core processor may enable multiprocessing within a single physical package. Additionally or alternatively, the processor 1320 may include one or more processors configured in tandem via the bus to enable independent execution of instructions, pipelining and/or multithreading.

In an example embodiment, the processor 1320 may be configured to execute the instructions 1350 stored in the memory device 1340 or otherwise accessible to the processor 1320. Alternatively or additionally, the processor 1320 may be configured to execute hard coded functionality. As such, whether configured by hardware or software methods, or by a combination thereof, the processor 1320 may represent an entity (e.g., physically embodied in circuitry) capable of performing operations according to an embodiment of the present disclosure while configured accordingly. Thus, for example, when the processor 1320 is embodied as an ASIC, FPGA, and/or the like, the processor 1320 may be specifically configured hardware for conducting the operations described herein. Alternatively or additionally, as another example, when the processor 1320 is embodied as an executor of instructions (e.g., instructions 1350), the instructions may specifically configure the processor to perform the algorithms and/or operations described herein when the instructions are executed. However, in some cases, the processor 1320 may be a processor of a specific device (e.g., an image or video processing system) configured to employ an embodiment of the present disclosure by further configuration of the processor by instructions for performing the algorithms and/or operations described herein. The processor 1320 may include, among other things, a clock, an arithmetic logic unit (ALU), and/or logic gates configured to support operation of the processor 1320.

The communication interface 1360 may be a device and/or circuitry embodied in either hardware or a combination of hardware and software that is configured to receive and/or transmit data, including media content in the form of video or image files, one or more audio tracks, and/or the like. In this regard, the communication interface 1360 may include, for example, an antenna (or multiple antennas) and supporting hardware and/or software for enabling communications with a wireless communication network. Additionally or alternatively, the communication interface 1360 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some examples, the apparatus 1300 may be an access point (AP) or a non-AP station (STA) (e.g., such as a client device) usable in a Wi-Fi network operating in accordance with wireless standards (e.g., IEEE 802.11 standards). For example, the apparatus 1300 may be a terminal device, such as the STAs 115 of FIG. 1. As another example, the apparatus 1300 may be comprised in such a terminal device, for example, as a chipset configured to control the terminal device. As another example, the apparatus 1300 may be a non-AP STA, such as the APs 110 of FIG. 1. The apparatus 1300 may be caused or configured to perform at least the method of FIGS. 9-12 and/or any one or more of the embodiments described.

In an embodiment, at least some of the processes described herein may be carried out by an apparatus comprising means for carrying out at least some of the described processes.

Means for performing elements of the method as disclosed herein may include software and/or hardware components of the apparatus 1300. For example, the at least one processor 1320, the memory 1340, and the instruction 1350 form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor and at least one memory storing instructions that, when executed by the at least one processor, cause the apparatus to perform at least:
receiving channelization information associated with two or more wireless channels based on and including a wireless channel selected for non-primary channel access, NPCA, wherein the two or more wireless channels comprise an NPCA primary channel and one or more additional wireless channels selected based on the NPCA primary channel, and wherein the two or more wireless channels are selected to maximize usable bandwidth or avoid wireless channels used by at least one overlapping basic service set, OBSS; and
exchanging data via the two or more wireless channels including the wireless channel selected for NPCA.

2. A method comprising:
receiving channelization information associated with two or more wireless channels based on and including a wireless channel selected for non-primary channel access, NPCA, wherein the two or more wireless channels comprise an NPCA primary channel and one or more additional wireless channels selected based on the NPCA primary channel, and wherein the two or more wireless channels are selected to maximize usable bandwidth or avoid wireless channels used by at least one overlapping basic service set, OBSS; and
exchanging data via the two or more wireless channels including the wireless channel selected for NPCA.

3. An apparatus comprising at least one processor and at least one memory storing instructions that, when executed by the at least one processor, cause the apparatus to perform at least:
determining channelization information associated with two or more wireless channels based on and including a wireless channel selected for non-primary channel access, NPCA, wherein the two or more wireless channels comprise an NPCA primary channel and one or more additional wireless channels selected based on the NPCA primary channel, and wherein the two or more wireless channels are selected to maximize usable bandwidth or avoid wireless channels used by at least one overlapping basic service set, OBSS; and
signaling the channelization information to one or more stations, STAs.

4. The apparatus according to claim 3, wherein signaling the channelization information comprises indicating the NPCA primary channel.

5. The apparatus according to claim 3, wherein signaling the channelization information comprises indicating the NPCA primary channel in at least one of a beacon frame, management frame, probe frame, or (re-)association frame.

6. The apparatus according to claim 3, wherein signaling the channelization information comprises indicating the NPCA primary channel as part of an NPCA operation information field.

7. The apparatus according to claim 3, wherein signaling the channelization information comprises indicating, via a bitmap in a subfield of an NPCA operation information field, the two or more wireless channels.

8. The apparatus according to claim 3, wherein signaling the channelization information comprises indicating, via an NPCA channelization offset subfield of an NPCA operation information field, a first wireless channel or a last wireless channel of the two or more wireless channels relative to the NPCA primary channel.

9. The apparatus according to claim 3, wherein signaling the channelization information comprises indicating, via a disabled subchannel bitmap subfield, one or more wireless channels that are punctured in association with the two or more wireless channels.

10. The apparatus according to claim 3, wherein signaling the channelization information comprises indicating, via a bitmap within an NPCA operation information field, one or more wireless channels that are punctured in association with the two or more wireless channels.

11. The apparatus according to claim 3, wherein signaling the channelization information comprises indicating the NPCA primary channel as a first wireless channel or a last wireless channel of the two or more wireless channels.

12. The apparatus according to claim 3, wherein signaling the channelization information is based on a carrier frequency associated with the one or more STAs.

13. The apparatus according claim 3, wherein:
a basic service set, BSS, comprises the two or more wireless channels;
the BSS is associated with a first channelization configuration; and
the channelization information is associated with a second channelization configuration different from the first channelization configuration.

14. A method comprising:
determining channelization information associated with two or more wireless channels based on and including a wireless channel selected for non-primary channel access, NPCA, wherein the two or more wireless channels comprise an NPCA primary channel and one or more additional wireless channels selected based on the NPCA primary channel, and wherein the two or more wireless channels are selected to maximize usable bandwidth or avoid wireless channels used by at least one overlapping basic service set, OBSS; and
signaling the channelization information to one or more stations, STAs.

15. The method according to claim 14, wherein signaling the channelization information comprises indicating the NPCA primary channel.

16. The method according to claim 14, wherein signaling the channelization information comprises indicating the NPCA primary channel in at least one of a beacon frame, management frame, probe frame, or (re-)association frame.

17. The method according to claim 14, wherein signaling the channelization information comprises indicating the NPCA primary channel as part of an NPCA operation information field.

18. The method according to claim 14, wherein signaling the channelization information comprises indicating, via a bitmap in a subfield of an NPCA operation information field, the two or more wireless channels.

19. The method according to claim 14, wherein signaling the channelization information comprises indicating, via an NPCA channelization offset subfield of an NPCA operation information field, a first wireless channel or a last wireless channel of the two or more wireless channels relative to the NPCA primary channel.

20. The method according to claim 14, wherein signaling the channelization information comprises indicating, via a disabled subchannel bitmap subfield, one or more wireless channels that are punctured in association with the two or more wireless channels.
